(19) United States
(12) Patent Application Publication
(10) Pub. No.: US 2017/0278075 A1
(43) Pub. Date: Sep. 28, 2017

(54) PLATFORM/SYSTEM FOR THE MANAGEMENT OF THE SUPPLY OF ENGINEERING AND MAINTENANCE SERVICES

(71) Applicant: ACRELEC International Development, LTD, Hemel Hempstead (GB)

(72) Inventor: Jacques Mangeot, London (GB)

(21) Appl. No.: 15/080,257

(22) Filed: Mar. 24, 2016

(30) Foreign Application Priority Data
Mar. 24, 2016 (GB) 1605058.5

(51) Int. Cl. G06Q 10/00; G06Q 30/06

(52) U.S. Cl. CPC G06Q 10/20; G06Q 30/0609

(57) ABSTRACT

A computer-implemented platform for the procurement, the assignment to engineers and other technical experts, the management, the coordination, and the reporting of engineering and maintenance services of goods sold in a business-to-business environment and methods of use thereof. More specifically, a client-driven multi-mode service triage system for purchasing services, a supplier-driven system for selecting and dispatching, when required, appropriate resources to job sites to service goods sold by the supplier.

### FIELD OF THE INVENTION

A computer-implemented platform for the procurement, the assignment to engineers and other technical experts, the management, the coordination, and the reporting of engineering and maintenance services of goods sold in a business-to-business environment and methods of use thereof. More specifically, a client-driven multi-mode service triage system for purchasing services, a supplier-driven system for selecting and dispatching, when required, appropriate resources to job sites to service goods sold by the supplier.

### BACKGROUND

Multiple types of goods are sold in commerce to multiple types of customers. This technology generally relates to goods sold by a first business to a second business (B2B) to he used as part of their own trade. Over the second part of the 20th Century and the first part of the 21st Century, these goods have gained in complexity and functionality in one key aspect. Most of these goods include a mechanical assembly of complex parts or housing, or operate in tandem with electrical systems and wirings in order to empower complex software (local or remote) to be operated. For example, most goods have casings (mechanical) for housing a display (electrical) which runs software (software). As a consequence, these B2B goods are often of a nature which makes their installation, maintenance, repair, and servicing very complex.

To explain the inherent complexity of working on these new-generation goods, normal education institutions segments the fields of engineering as either mechanical engineering, electrical engineering or software engineering. Training in these three combined fields is both impracticable and outside the bounds of a normal three- or four-year education course. Understandably, usefulness of the technology described hereafter is to help single-field engineers overcome these obstacles and be proficient in all fields linked with the repair, maintenance or servicing of these new-generation goods.

When these new-generation and complex goods are being serviced, maintained, and repaired, the amount of tools (software, hardware, components, elements, pieces, parts, etc.) needed to face all situations greatly increases. The same way it is unreasonable to assume any one person may he educated and trained in all of the fields needed, that same person cannot be reasonably asked to have at his/her disposal all of the tools needed to fix any problem encountered. The secondary usefulness of the technology described hereafter is to help manage and regulate the flow of equipment, spare parts, replacement parts, tools, software patches, components, electrical diagrams, etc. needed to service, maintain and repair these new-generation goods in a more effective way.

As these goods increase in complexity, so does the number of possible problems which may arise from these goods to be serviced. Some issues may appear complex to resolve when in fact they require only a very gentle nudge of one of these systems. Conversely some seemingly minor problems may in fact be indications that important repairs are needed. This creates a need for an overall system and associated services capable of quickly and cost efficiently conducting triage and diagnostics to be able to provide the fight solution.

Buyers of goods may be apprehensive about the complexity of the devices and the costs associated with post-purchase use. In the area of retail, customers who buy complex goods look for warranties, extended warranties, and leasing programs. For example, copiers are often rented from the manufacturer or a distributor that offers full service on the device. In the context of B2B, often things are not so simple. Often, the purchaser may have in-house experts, engineers or technical specialists who can help with the post-purchase maintenance, repair and upkeep of goods purchased. By leveraging a select team of in-house individuals, a business can lower the cost of maintenance and repair when compared to the cost of third-party servicers. What is needed is a system and platform device capable of leveraging these capacities that a purchaser of goods may, over time develop, own or acquire.

Further, both of the businesses in a B2B relationship in which these goods are exchanged have a strong desire to offer services linked to these goods in a way which is more fluid, fast, efficient and cost effective. What is needed is a system/platform or method of use thereof which allows the person who ultimately performs the work to optimize this work in a way which lowers costs by removing inefficiencies such as initiating work, traveling to the point of work, or reporting work orders as they are performed. In addition, what is needed is a platform that enhances and simplifies the experience for all parties involved be it one of the two businesses exchanging the service, the service provider, or agents of these businesses involved in the process of securing the service as required.

One final additional need and usefulness of these businesses is the capacity to anticipate costs associated with these services, to optimize them as needed and hopefully to expand the scope of the goods being covered.

As part of this description and associated claims, the services are being provided at all stages of life of complex goods. As a consequence, the words “service,” “maintenance,” “work,” “update,” “upgrade,” “repair,” “warranty,” and any other related work that can be performed by a service provider on goods should be understood generally as being broad and covering all aspects of the service being performed. The broad use of these terms should not be construed in a way which limits the ordinary definition of these terms or conflicts with any additional meaning given by one of ordinary skill in the art.

As part of this description and associated claims, the inventor will describe the field of automated food-ordering kiosks, which includes displays, electronic components, software interfaces, mechanical parts and wireless interfaces. While one possible use is described as to the goods, this document should not be construed to limit the scope of the invention as described in this embodiment. As described, this new and useful technology can be implemented in any hardware and/or software platform/system for use on any type of goods in commerce.

Finally, this disclosure includes terms such as “engineer,” “technician,” “technical specialist,” “agent” or even “service provider” which generally relate to one or more individuals with some technical knowledge in one or more technical areas that can be used to offer services to the goods described here. One of ordinary skill in the art will understand that these terms can be interchanged and should not be construed in a limiting manner simply because they are applied to one type of technology or another.

### SUMMARY

A computer-implemented platform/system of use thereof for the procurement, the assignment to engineers and other technical experts, the management, the coordination, and the reporting of engineering and maintenance services of goods sold in a business-to-business environment and methods of use thereof. More specifically, a client-driven multi-mode service triage system for purchasing services, a supplier-driven system for selecting and dispatching appropriate resources to job sites when required to service goods sold by the supplier.

### BRIEF DESCRIPTION OF THE DRAWINGS

Certain embodiments are shown in the drawings, however, it is understood that the present disclosure is not limited to the arrangements and instrumentality shown in the attached drawings.

FIG. 1 is a general illustration of the different actors using a platform 1 for the management of the supply of engineering and maintenance services and method of use thereof, according to an embodiment of the present invention.

FIG. 2 is a schematic illustration of possible hardware used in a network configuration.

FIG. 3 is a schematic illustration of the different internal hardware layers to process information by the different hardware elements shown at FIG. 2 for use as part of the platform shown at FIG. 1, according to an embodiment of the present invention.

FIG. 4 is a schematic representation of how software, such as an App-based software can be used over a series of network servers to help enhance the software layer of the different hardware elements shown at FIG. 2 for use with a platform as shown at FIG. 1 according to an embodiment of the present invention.

FIGS. 5, 6, and 7 are illustrations of the different option plans for service available to clients using the platform described at FIG. 1, according to an embodiment of the present invention.

FIG. 8 is a ranking of levels of competency of engineers on the platform shown at FIG. 1, according to an embodiment of the present invention.

FIG. 9 is an illustration of the process linked to the cycle of certification to evaluation of external engineers using the platform shown at FIG. 1, according to an embodiment of the present invention.

FIG. 10 is an illustration of the different portal sections and functions of an App-based software to enable the platform shown at FIG. 1, according to an embodiment of the present invention.

FIG. 11 is an illustration of the details of selecting the services required by a client using the platform as shown at FIG. 1, according to an embodiment of the present invention.

FIG. 12 is an illustration showing the substeps associated with the bidding process for assigning an external engineer to a client work request, according to an embodiment of the present invention.

FIG. 13 is an illustration of the App page where an onsite button is assigned to an engineer according to an embodiment of the present invention.

### DETAILED DESCRIPTION

For the purposes of promoting and understanding the principles disclosed herein, reference is now made to the preferred embodiments illustrated in the drawings, and specific language is used to describe the same. It is nevertheless understood that no limitation of the scope of the invention is hereby intended. Such alterations and further modifications in the illustrated devices and such further applications of the principles disclosed and illustrated herein are contemplated as would normally occur to one skilled in the art to which this disclosure relates.

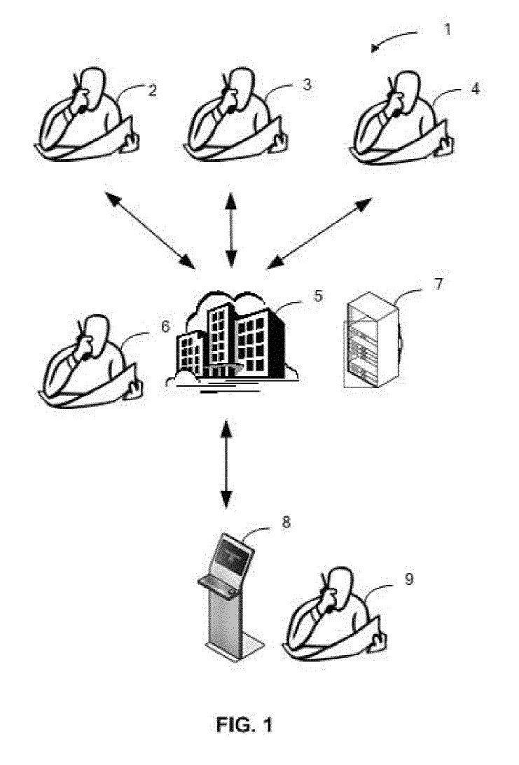

FIG. 1 is a general illustration of the different actors using a platform 1 for the management of the supply of engineering and maintenance services and method of use thereof according to an embodiment of the present invention. As shown, the platform 1 as generally construed may include the different actors accessing the system using different types of electronic devices. As shown at FIG. 1, a product 8 is sold and/or installed at a physical location. In one preferred embodiment, a kiosk 8 is sold and is used in the front area of a restaurant by its customers to order food from the menu. The kiosk or good 8 as shown is made of a human-size mechanical shell, housing multiple electronic systems, working to empower software layers to connect the kiosk 8 or good 8 to the order-processing system of the restaurant and to the outside system for maintenance and repairs. As shown, a person 9 can be located at the physical proximity of the kiosk 8, for example, an employee of the restaurant at which the kiosk 8 is installed, or is a person tasked with the maintenance and repair of all equipment owned by the restaurant by the client having purchased or leased the kiosk 8.

As shown, the platform 1 connects via technology, the below-described three layers of actors: first, a handful of service providers 2, 3 and 4, for example, multiple engineers located at different locations around the world. As shown, these engineers 2, 3 and 4 can use a portable device to connect remotely to a system shown at 5. Purely for the convenience of explaining this process, these engineers or maintenance agents 2, 3 and 4 are described hereafter as “external engineers.” In contrast to external engineers, the system is, in part, housed in a computer server 7 either on the site or offsite as is well known in the art of software technology. In some contemplated embodiments, the system operator 5 may also use and rely on some engineers and maintenance experts located internally 6 or having a different connection to the system. Purely for the convenience of explaining this process, these engineers or maintenance agents are referred to as “internal engineers.” Finally, in many cases clients have a person 9 in proximity who also could be an engineer or a maintenance expert. Purely for the convenience of explaining this process, these engineers 9 on the payroll or paid by the client using the kiosk 8 are described hereafter “client engineer(s).”

One of ordinary skill in the art of structuring work and capable of understanding the usefulness and features of the current platform will see how, while one embodiment is shown, multiple different physical configurations can be offered. Further, this configuration should be understood as adaptive to the needs of clients who grow or shrink in size. For example, a small client may not have a client engineer when it purchases its first good 8. This client may also desire to rely mostly on the help of internal engineers 6 from the corporation linked with the good 8 to better control the process. As the client grows, the platform as shown can be expanded easily and organically. The client will hire one, two or more client engineers 9 who will, in turn, be able to work either with internal engineers 6 or external engineers 2, 3 and 4. As shown below, since the system allows for external engineers 2, 3 and 4 to personalize their relationship with the client directly, this client may use these external engineers 2, 3 and 4 to replace the client engineer 9, if need be.

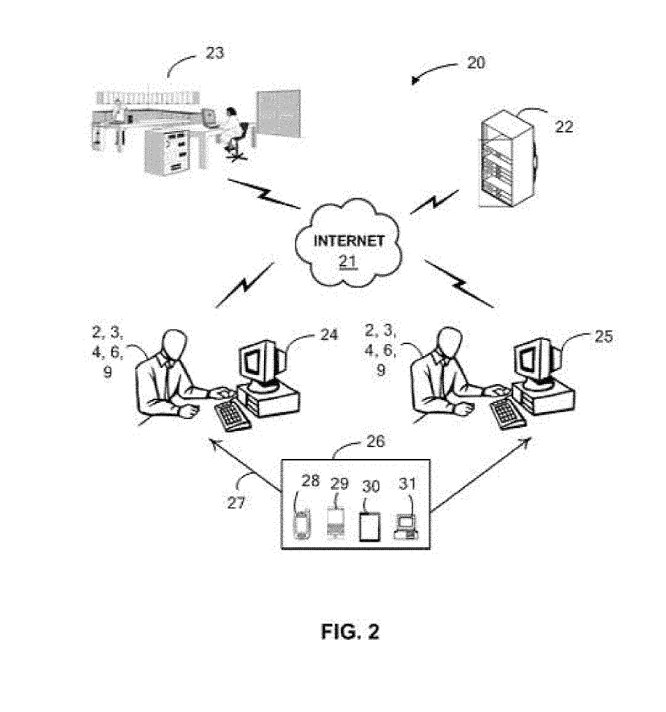

Now that the different actors have been shown in FIG. 1, it now becomes necessary to explain and enable the basic structure in terms of hardware which allows for this system/platform 1. FIGS. 2, 3 and 4 describe with some sufficient level of specificity the hardware and software which are used.

FIG. 2 is a schematic illustration of possible hardware used in a network configuration. Back in 1990, when the internet was made available to the public, few were familiar with the general interconnectivity of the hardware elements used in any platform 1 or system. To enable patent applications, much description of the interconnectivity of these elements became necessary. With time, those of ordinary skill in the art realized how each of these elements and pieces, either in hardware and/or software operate. To help with this disclosure, what is described hereafter is one configuration of how different elements can operate in tandem.

FIG. 2 shows at the center 21 how the interact can be used as the protocol of communication using, for example, the HTML protocol. Other networks are also contemplated, for example wireless networks, internal networks, or other non-html networks. As the current platform is expanded and new technology arrives, one of ordinary skill will know that the concepts shown herein can be applied to other networks, and to new technology as currently used over the internet and wireless networks.

Shown is a remote data server 22, used sometimes to store data used by any software application. For example, in recent years Cloud technology allows for more fluid data management by relying on a network of servers 22 located in different physical locations around the world. As shown, different rooms 23 are connected to the interact to help manage the system, offer users rights and manage the flow of data. As shown different pieces of electronics 24, 25 are in turn connected to the internet 21 using their own communication protocols to help large numbers of users get access. As shown, the users may he individuals 2, 3, 4, 6 or 9 as shown at FIG. 1. To help the reader understand, while the illustration shows desktop computers 24 and 25, over time users have become more familiar with less bulky systems and equipment capable of also accessing the internet 26. For example, today's wireless phones now offer owners almost full surfing capabilities through browsers and double capacity transceivers. As shown, users 2, 3, 4, 6 and 9 can use a desktop 31, a tablet 30, a smart phone 29 or a simple phone 28. In each case, the users 2, 3, 4, 6 and 9 simply connect 27 the device 26 using access and password features on a software layer. What is not described but is known is how the different ports and communication protocols interconnect using normal connectivity technology. For example, modern tablets can connect through wireless connection, data connection over phone networks, by using Bluetooth® or any other data transfer standard.

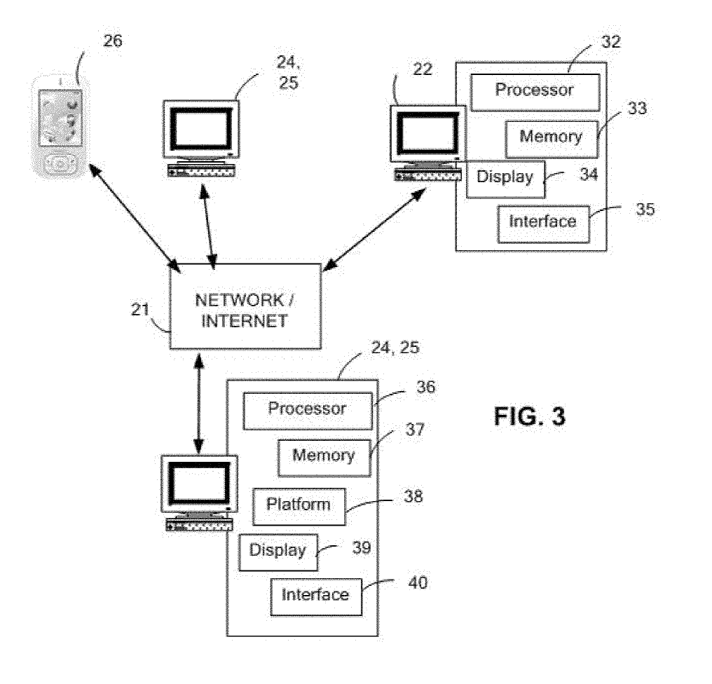

Now that the general structure of users as shown at FIG. 1 has been explained and the overall network configuration of hardware 20 as shown at FIG. 2 is accessed by these different users, we will next explain how each of the devices 26 can host and empower multiple types of software to operate within these devices alongside (when needed) phone communication. FIG. 3 is a high-level schematic of the different internal hardware layers to process information by the different hardware elements shown at FIG. 2 for use as part of the platform shown at FIG. 1 according to an embodiment of the present invention.

Illustrated here are the different elements 22, 24, 25 and 26 connected to the network 21. What is illustrated is how each of these devices has at least one processor 32, 36 which requires memory 33, 36 to operate. On the memory is written software instructions written in a software language and each of the devices relies on multiple layers of hardware technology which operates to empower ports, clocks and other key features including providing the capacity to run programs in memory and then execute the program in a way which can result in outputs to be processed by the system. These devices also generally have ad display 34, 39 of one type or another to interact with the user, and also have an interface 35, 40 of one type or another such as a keyboard or a mouse, to help exchange information with the user. As shown, the platform 38 or executed software used in the current invention is shown on the device 24, 25. This is designed to illustrate generally software applications executing on the device 24, 25 for one or multiple use. While this description is broad and general, at the current moment in time, it is sufficient to empower one of ordinary skill to understand how the below-described system will be implemented without undue experimentation and testing.

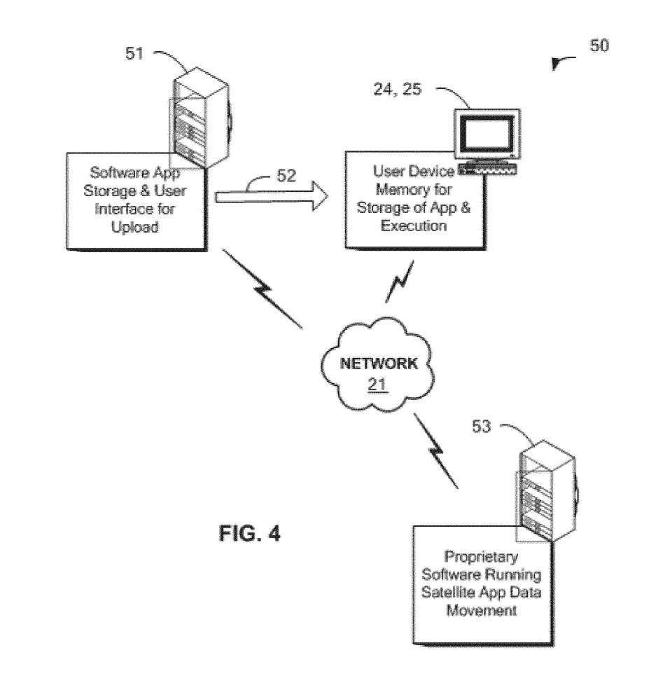

Recently, with the expansion of connectivity to hand-held portable devices, software which once was confined to desktops or servers now have migrated to these devices. In fact, a remote store on a server houses multiple “Apps” (an executable file in .app format) which can be uploaded directly by a user into the memory of a portable device for execution. Most of these Apps then connect via wireless to a remote server where the main software application resides and operates. These Apps often serve as satellite software capable of interacting with a remote base for multiple functions. Since this technology has greatly expanded in the last decade, FIG. 4 is a schematic representation of how software, such as an App-based software can be used over a series of network servers to help enhance the software layer of the different hardware elements shown at FIG. 2 for use with a platform as shown at FIG. 1 according to an embodiment of the present disclosure. As for the above-suggested embodiments, this one is simply illustrative and not designed to limit the platform in any way.

Apps, once they are programmed, are uploaded using an online portal onto a service provider, for example, the AppStore® from Apple®. This is shown at FIG. 4 as server 51. Users will then access the server 51 via the network 21 and, using their own devices, upload the App 52 required from the server 51. Once added to the memory of the device 24, 25, it will be executed and an icon-based interface will help a user launch the App locally. Using, the network 21, once the App is launched, it will reach out to a second remote server 53 where data is stored on the main software executes and is in contact with other parts of the system. Since this technology is rather new, it is expected this process of sharing and managing Apps locally and remotely will evolve with time.

Currently, many software programs use a local HTML browser installed on the computer, along with their associated displays and interfaces, for example tablets, cell phones, portable or fixed computers with a commercial browser tool such as Internet Explorer® or Mozzilla® to exchange information for the most part in the form of HTML script and data linked with the HTML script and display based on the format of the browser. The platform software 8, while programmed in any of multiple programming languages, relies on any one of multiple database tools, and can be made to read and generate content that can be accessed by the remote HTML browsers.

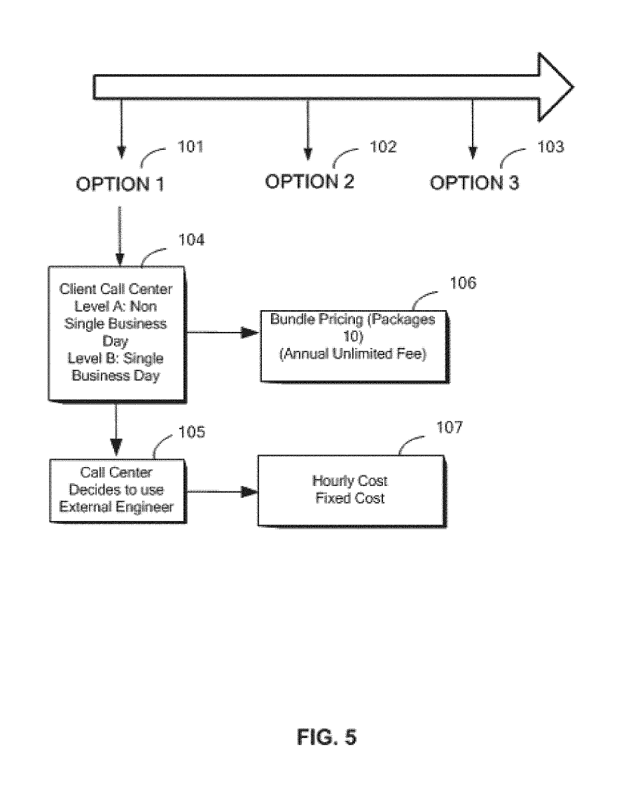

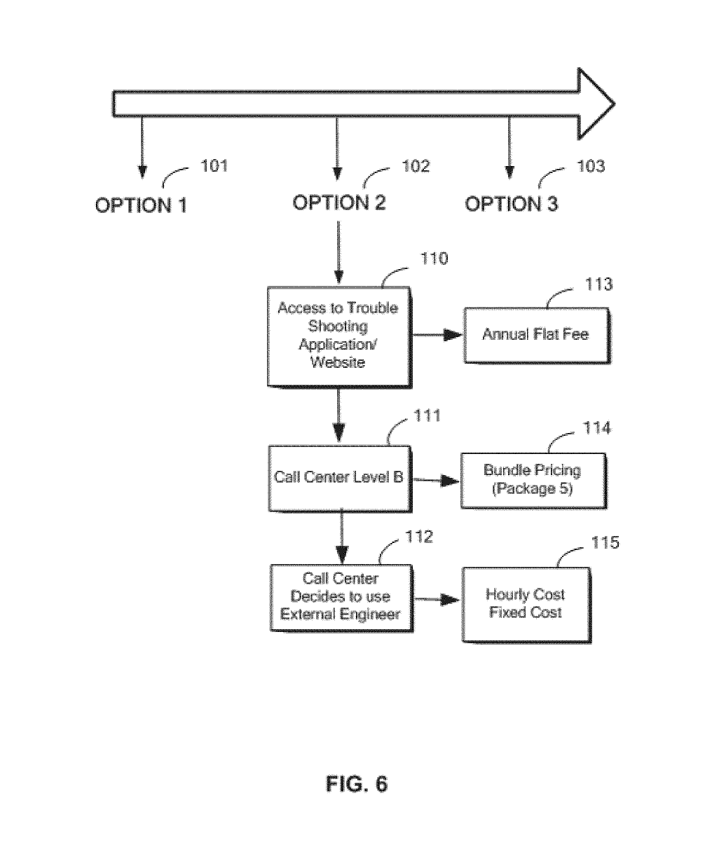

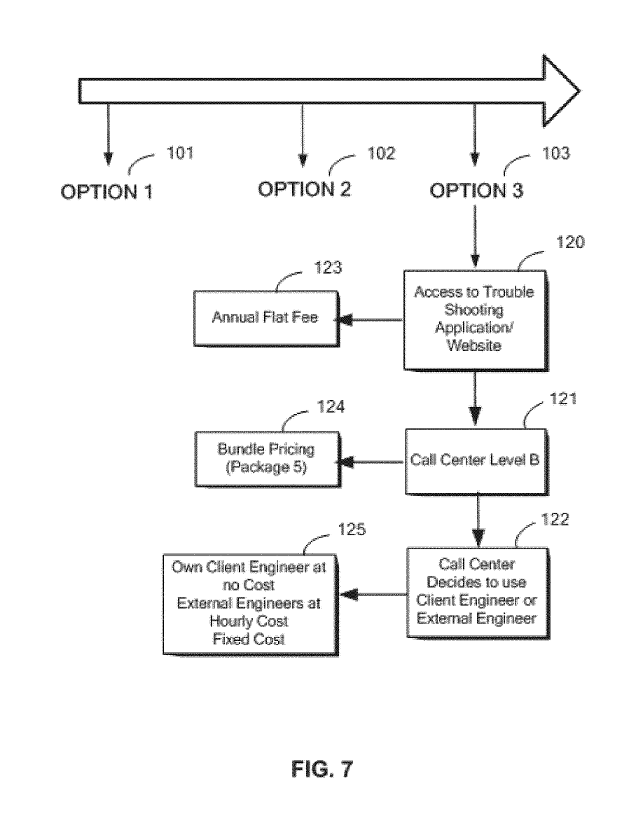

FIGS. 5, 6 and 7 are three illustrations of the different option plans for service available to clients using the platform described at FIG. 1, according to an embodiment of the present invention. First, an arrow from left to right illustrates that a spectrum of services can be offered to clients using the platform 1. Three sample options 1, 2 and 3 are shown as 101, 102 and 103. FIG. 5 illustrates the breakdown of services and associated pricing method associated with option 1 101. FIG. 6 illustrates the breakdown of services and associated pricing method associated with option 2 102, and FIG. 7 illustrates the breakdown of services and associated pricing method associated with option 3 103.

Option 1 101 is a service model through which a client is set up with a plan 104 in which the call center may be called by the user (owner or renter of goods) for normal non-urgent calls to be handled as the call center views these calls as Level A. Most time, this level of priority will result in service being dispatched more than 24 hours after the call is placed. At Level B, the call is handled with greater expediency and will often be resolved within a single business day. What is contemplated is the use of an annual unlimited fee to use the call center or to the purchase bundle 106 (example 10) of calls resulting in service being dispatched and handled. While one type of bundle is shown, one of ordinary skill will recognize that other size packages are also available. With Option 1 101, the call center (and not the user) can decide to escalate the matter away from internal engineers to instead reach out to external engineers using the platform for bid solicitation as described hereafter. The cost of using this external service, since it will be done at the direction of the call center, may be at a fixed cost or at a cost per hour billed to the call center 107. In this example, the user may not know that a Level 2 call, as part of the bundle purchased, will instead be handled by an external engineer and that the cost may be absorbed as part of the package.

Option 2 102 corresponds to a different level of service which includes access 110 to trouble shooting applications and website information for the client. When a client has purchased a bundle of engineering service events, before such an event is charged, the client can access information which often will allow a client engineer 9 to resolve the issue directly. This access to information can be done directly with an annual flat fee 113. In a subsequent level 111, the client is then directly given Level B priority (i.e., single-day call), and also the price 114 can be associated with a bundle pricing or a larger flat fee. Finally, the call center 107 can decide to use and reach out to external engineers at an hourly cost or a fixed cost 115 as described below.

Option 3 103 as shown on FIG. 7 also offers clients the opportunity to access a trouble shooting application/website 120 having an annual fee 123 and, in a second alternative, either use the Call Center Level B 121 using bundle pricing 124 or use its own client engineer 122 or external engineers, whichever is more convenient to the client, at a rate based on availability 125.

Certification of External Engineers

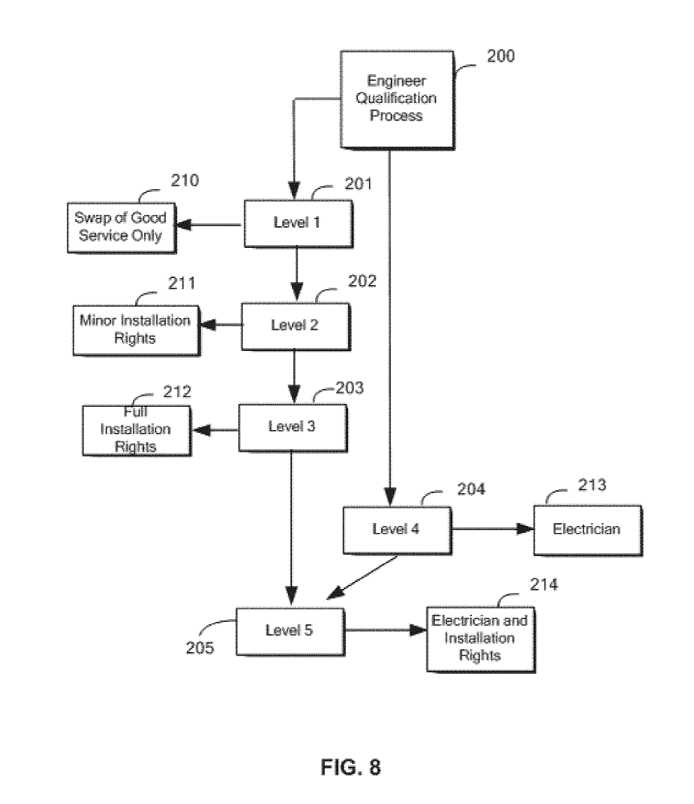

One of the first elements of quantification is the need to understand and manage a wide range of services, linked with multiple different problems regarding the complex goods that can be performed by engineers having all or only a partial number of skills required to service the complex goods as a whole. With time, training and experience, the same engineers will increase in skill and thus in pay and be able to service more complex issues. The platform is designed to help triage emergencies and calls based on their respective levels of complexity and area of expertise. FIG. 8 shows a diagram in which skill levels of engineers 200 are broken down to at least five levels 201, 202, 203, 204 and 205. For example, the diagram as offered is based on food kiosks 8 which have has a primary software component, a secondary electrical parts component, and only a minor mechanical work component.

As shown, Level 1 of competency 201 represents an engineer with only the right to swap the goods if required 210. Level 2 of competency 202 represents an engineer with minor installation rights 211. Level 3 of competency 203 represents an engineer with greater rights who can perform the full initial or later installation. In a different skill set, some engineers will be electricians 213 and be given Level 4 access. These persons will he able to handle some or all of the other levels 1, 2, 3 or 5 if, in fact, they are qualified to do so. While one type of qualification is given, the system can also use three qualification levels (Mechanical Level 2, Electrical Level 3 and Software Level 4).

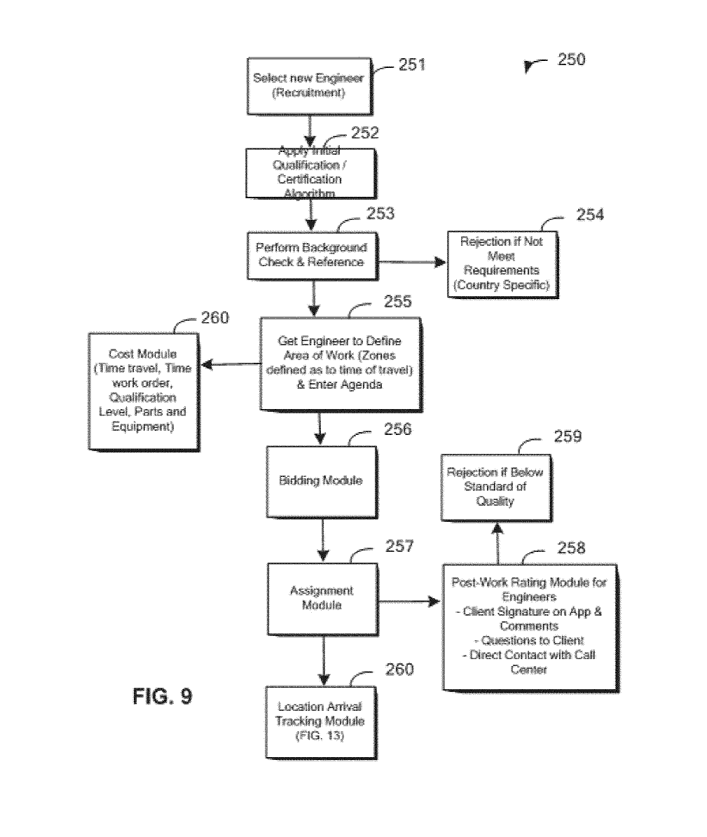

FIG. 9 is an illustration of the process 250 linked to the cycle of certification to evaluation of external engineers 2, 3 and 4 as shown at FIG. 1. As shown at box 251, the first step is a recruitment of engineers or other technical experts from multiple locations. These engineers will be recruited from universities, small companies using multiple traditional medias like advertisement on social media, local papers or other social media. The engineers will also provide schedules of availability (days, hours, vacation) which will allow the system to manage availability in subsequent steps. Furthermore, these engineers will also enter areas in which they can perform a call (country).

At step 252, the system, using the logic shown at FIG. 8, and also some testing and multiple-choice question exams, will operate to qualify and certify the engineer. For example, an engineer can be given Level 3 Certification (element 203) but told if they ever acquire electrician's certificate, they would be Level 5 Certified. In a subsequent step 253, background checks are performed and references entered into the system as part of the initial application 251 which will he checked. What is contemplated is the rejection 254 of applicants if the background and other checks have not been satisfactorily met for the location in which the engineer is located.

Once the external engineer 255 has been checked and admitted into the system, the external engineer will define zones (e.g., 30-min. travel, 60-min. travel, no work areas) into the system. For example, some metropolitan areas might be dangerous to visit. A cost module 260 allows the engineer to prepare an internal quote using a part of the software. For example, the external engineer can enter his/her gas cost, the vehicle rental cost, the time, the parts and generate for himself/herself a net cost of $900 for the service call.

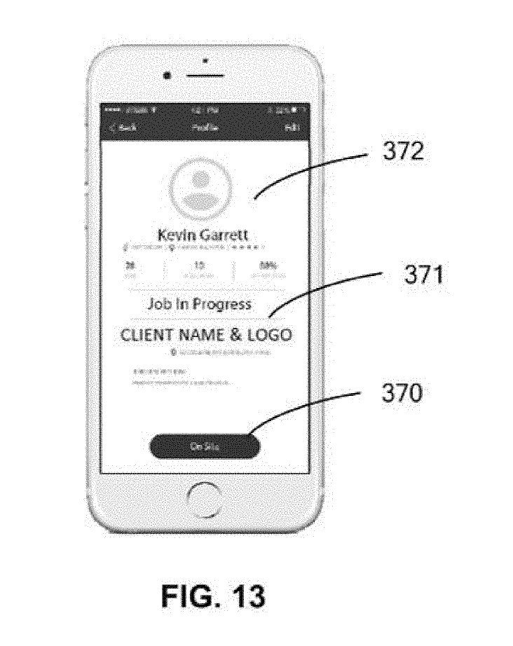

At step 256, a bidding module is used by the external engineer (defined with greater detail below) which, in turn, results in the offer 257 of the job to one of multiple external engineers bidding on the process. As shown at FIG. 13 with greater detail, a new module manages 260 the location arrival and the tracking of the engineer. At step 258, a module is created which is accessed by the client in order to generate a post-work rating of the engineer who performed the work. The client enters information and will be asked satisfaction-oriented questions to be answered. The client also is given a location to sign and give comments. At step 259, if the ratings fall below a set level of quality, for example a 50% or B-approval rating over the last five jobs, then the relationship with the external engineer will be terminated. In one contemplated embodiment, if an external engineer receives less than a 50% rating in quality after three jobs, the relationship will be terminated. An electronic warning may be sent after two such low-rated jobs.

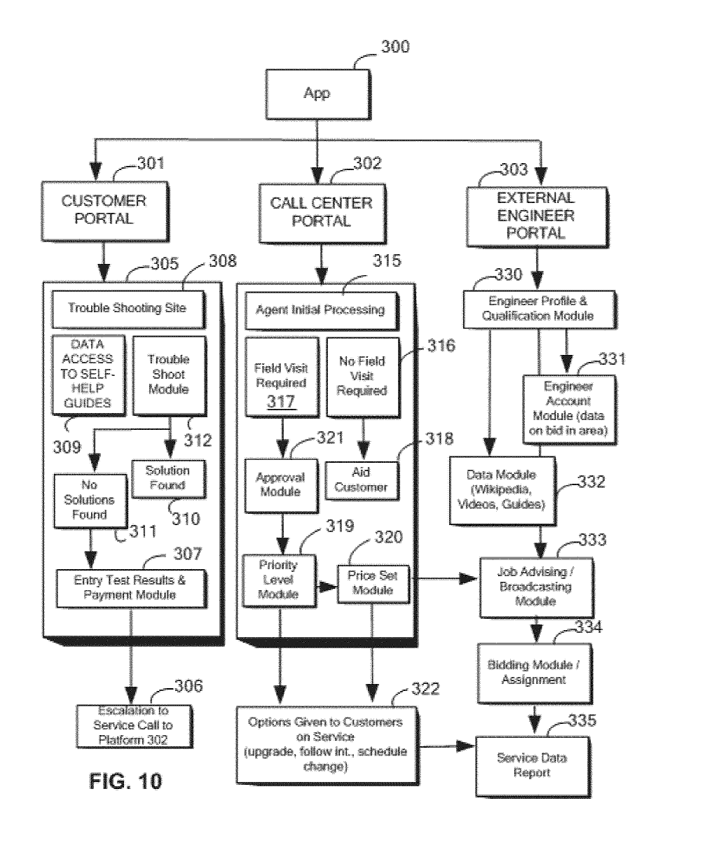

FIG. 10 is an illustration of the different portal sections and functions of an App-based software to enable the platform shown at FIG. 1 according to an embodiment of the present invention. As illustrated, on the display of devices used as shown on FIG. 1 and as part of a system illustrated at FIGS. 2 through 4, is an App or any other type of software having three portals 301, 302 and 303. The first portal 301 is for customers using the good illustrated as 9 on FIG. 1. The second call center portal 302 is the call center portal illustrated by the layers 5, 6 and 7 on FIG. 1, and the external engineer portal 303 is illustrated as 2, 3 and 4 on FIG. 1. Some key functions and functionalities are associated with menu functions.

Turning to the customer portal 301, as for the other portals to be entered via known methods of authentication (password, I.D.) a customer 305 will be given access to a database of information and a trouble shooting site 308 (as described above as 110 at FIG. 6). As part of the site 308, two types of information are given, for example, self-help guides 309 and troubleshooting modules and procedures 312 which allow a step-by-step analysis using visual images and other types of information. While two types of information are given 309, 312, what is contemplated is the use of multiple different tools to help at the customer portal 301 level. As shown at FIG. 10, using the trouble shooting module 312 and other info 309, a customer can find a solution 310 in which case there will be no need for further help. If customer cannot find the solution 311, a module allows the client 307 to enter test results and payment (if needed) to escalate the service 306 to the call center.

A call center portal 302 is a location in the App where a customer places a call 306. Once the software is accessed, there is an initial agent who processes the request 315. This agent will determine whether he/she can help the client 316 or if there is a field visit required 317. If no visit is required, the App will ask if the customer has been helped 318 and to confirm. In the event the field visit is required 317, a module is designed to enter the request into the system 312 after approval, based on client information. The system assigns a priority level 319 to the call. This module 319 takes into consideration many factors relating to the nature of the call, the nature of the client, external parameters such as client needs, public safety or other variables. This priority level module 319 will then use the price-set module 320 to help determine the resources available to help find the right external engineer. As shown, once the price is set (for example $700), the client is then informed of the price 322 and can then do many things to help secure better or cheaper service. For example, the set price of $700 can be upgraded (i.e., overnight service and the price-set module will return a different price ($900) as the service is upgraded. The client may desire, for example, service at a specific time of low attendance, night service, etc. at a lower price.

In parallel, external engineers 2, 3 and 4 as shown at FIG. 1 enter their own designated portal 303 on their own version of the App. Once the engineer profile and qualification module have passed 330 (which can be done only once and the information is entered about preferred areas 331, the engineer may surf to secure a bid on the job advertising and broadcasting module 333. The data module 332 is a tool used by these engineers to help perform the work. The engineer will then bid 334 on the job being offered (in the example above at $700). Since the job is offered at $700, to secure the bid, as described hereafter, the external engineer may bid lower. Finally, as shown, a service data report module 335 allows for the work, as processed, to be reported.

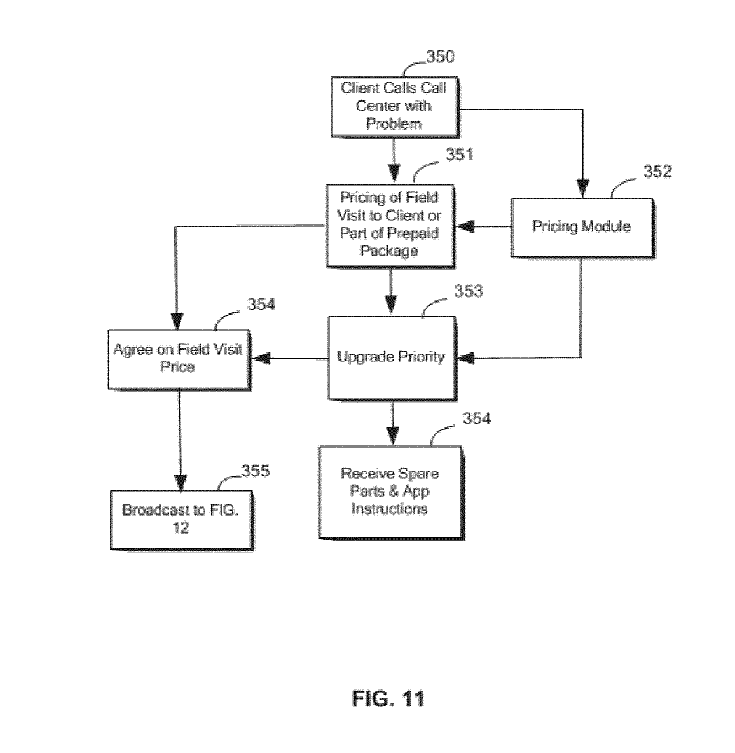

FIG. 11 is an illustration showing selection of the services required by a client using the platform as shown at FIG. 1 according to an embodiment of the present invention. This figure helps better illustrate the steps shown at FIG. 10 as 319, 322. As shown, a client calls the call center with a problem 350. The system estimates the price of a field visit as part of a price quotation or a prepaid package 351. The client can either agree on the price of the visit 354 or ask for an upgrade in priority 353 which will rely on the pricing module 353 to determine the new price. In one embodiment, the client is informed as to how to receive spare parts 354 and given an instruction so the client engineer 9 can proceed with the repair. In the event a price is agreed upon, the request is then broadcast 355.

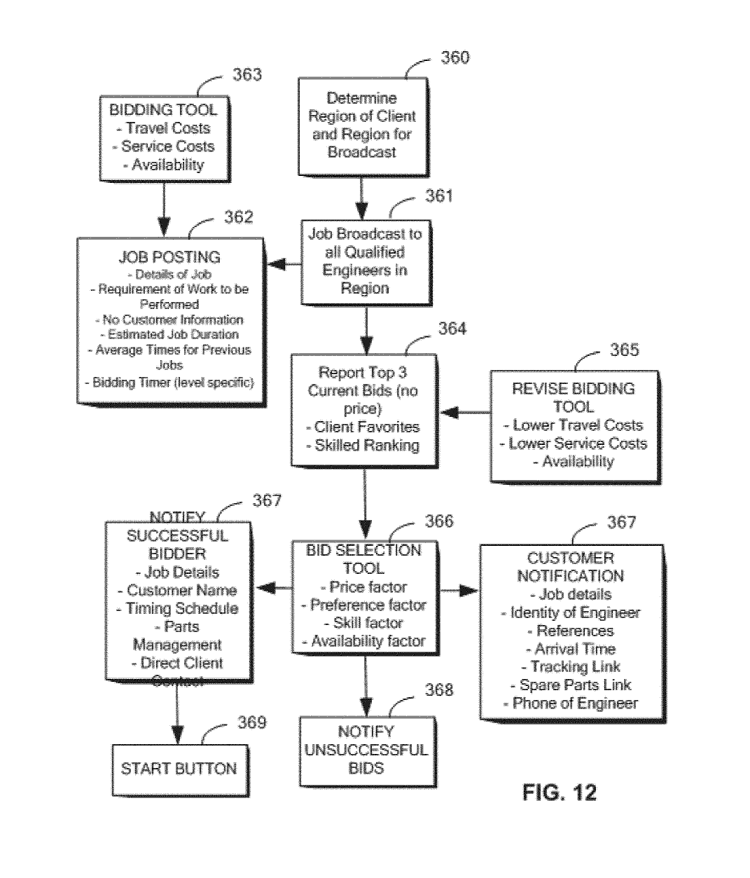

FIG. 12 is an illustration giving greater details as to the sub-steps associated with the bidding process for assigning an external engineer to a client work request, according to an embodiment of the present invention. At step 360, the system first determines a region of client and a region to broadcast for the job to be performed. For example, if the client resides in Paris, the broadcast can be sent to anyone who has entered a capacity to service Paris within 30 minutes of bid area 331 on FIG. 10. At step 361, the job is broadcast to all qualified engineers (step 330 on FIG. 10) who also are in the region. Information 362 is given as to what, in one embodiment, the job posting will contain. For example, the details of the job, the requirement of work to be performed, only partial customer information for preservation of anonymity, an estimated job duration (e.g., two hours), an average time for previous calls (e.g., two hours), and a bidding timer (e.g., three hours) with or without a suggested opening bid. At step 364, the top three bids are listed, in this example, $700, $690 and $680. For each, other, secondary parameters can be listed, for example regarding the skill level a client may prefer to bid $700 if the skill level is 5. In one embodiment, an external engineer can revise bids 365 to lower its own bid to win by doing multiple different recalculations.

In a subsequent step, once the timer has reached zero and all bids are in, a bid selection tool 366 is used to determine the winning bid. As explained above, services are not goods and the sale of services and their selection are rarely based on only one factor, such as price. Very often, other factors such as the preference of a client, the skill level of the engineer and the availability determine the winner. Once the bid is selected at 366, the customer 367 is notified and is given job details, the identity of the external engineer, its references, the arrival time, the tracking link using gps, a list of spare parts and their delivery schedule, and the contact information of the engineer.

What is also unique, novel and not obvious is the interrelation of these different individual useful concepts into a large platform and associated system which allows for the optimization of professional services as a whole from the securing of resources, the management of the costs related to the services and payment of the resources, to the performance of the these services as a whole and as part of a geographical map.

While features and functions of the platform and associated systems are explained in greater details, one of ordinary skill in the art will recognize both the usefulness and the operativeness of the platform and the associated system. For example, using a server, a group of hand-held devices and the appropriate software layers as described, this platform operates to help multiple service providers, with the help of a call center to be able to quickly and efficiency sign up, qualify themselves, bid and secure work, coordinate movement to and from the worksite, coordinate spare parts management, and also reporting and evaluation as part of the system as a whole.

In addition to notifying the customer 367, the successful bidder (and other bidders 368) can he notified. The successful bidder will be notified of the job details, the customer contact information 371, the timing schedule, the parts and direct contact information for the client 372. FIG. 13 is an illustration of the App page where an onsite button 369 on FIGS. 12 and 370 on FIG. 13 is given to an engineer, according to an embodiment of the present invention.

What is claimed is:

1. A platform with a computer-implemented software system for the procurement, assignment and performance of services, the platform comprising:
a good in the custody of a client in which said good is in need of repair or maintenance, said client having at least a client device with a processor, an interface and a memory in connection with the processor for executing software uploaded from an App server over a network, wherein the client device has access to said network for communication with a system for the procurement of services over a client portal over the interface of the client device;
a plurality of external engineers each capable of offering services for the good, each external engineer located in a geographical region in physical proximity of the good and wherein each of said plurality of external engineers having at least an external engineer device with a processor, an interface and a memory in connection with the processor for executing software uploaded from an App server over a network, wherein the external engineer device has access over said network to the system for the procurement of services over an external engineer portal over the interface of the external engineer device;
at least one internal engineer capable of offering remote help relating to servicing the good, the at least one internal engineer with an internal engineer device with a processor, an interface and a memory in connection with the processor for executing software, wherein the internal engineer device has access to a computer server hosting the system for the procurement of services in connection via the network, in turn, with the client device and the external engineer devices, wherein the internal engineer device has access to the system for the procurement of services over a call center portal over the interface of the internal engineer device;
the system for the procurement of services comprising the following software operations:
a module for the triage of service type;
a module for the qualification of external engineers;
a system for the processing of external engineers;
a price set module;
a bidding module; and
an assignment module.

2. The platform of claim 1, wherein the module for the triage of service allows a client to select between the following three options: (1) choice between the use of internal engineer services or external engineer services, (2) choice between the use of trouble shooters data, internal engineer or external engineers, or (3) choice between trouble shooters for data, internal engineer or client engineer.

3. The platform of claim 2, wherein the module for the certification of external engineers includes at least a first set of subsequent certification levels based on a level of knowledge in a first field, at least a second certification level based on a level of knowledge in a second field, wherein one certification level requires knowledge in both the first field and the second field.

4. The platform of claim 3, wherein the first field is installation of goods and associated parts and the second field is electrician knowledge.

5. The platform of claim 4, wherein the first set of subsequent certification levels includes the swapping of the good, minor installation rights and frill installation rights.

6. The platform of claim 5, wherein the system includes a recruitment phase, a phase for the initial application by the external engineer, a determination of the certification level by the module for the certification of the external engineer, a background verification phase and an area of work definition phase by the external engineer.

7. The platform of claim 6, wherein the price set module is designed for iterative function as entry parameters such as schedule changes, quality of services and upgrades are given by the client.

8. The platform of claim 7, wherein the bidding module includes a broadcast of a priced job posting to all qualified engineers in a region, reception of bids from external engineers, a broadcast of a report of the top bids within a bidding period, a notification of successful bidder with relevant information, and a notification to customer with external engineer information.

9. The platform of claim 8, wherein the notification to customer includes phone contact with the external engineer.

10. The platform of claim 9, wherein the notification to the successful bidder also includes a start button for the job, to provide the customer with a way to review the work performed.

11. A computer-implemented software system for the procurement, assignment, and performance of services, the system comprising:
a system for the procurement of services accessed by a client having at least a client device with a processor, an interface and a memory in connection with the processor for executing software uploaded from an App server over a network,
wherein the client device has access to said network for communication with the system via a client portal over the interface of the client device, the system also accessed by a plurality of external engineers. each capable of offering services for the good, each external engineer located in a geographical region in physical proximity of the good,
wherein each of said plurality of external engineers having at least an external engineer device with a processor, an interface and a memory in connection with the processor for executing software uploaded from an App server over a network,
wherein the external engineer device has access, over said network, with system for the procurement of services over an external engineer portal, and at least one internal engineer capable of offering remote help relating to service of the good over the system, the at least one internal engineer with an internal engineer device with a processor, an interface and a memory in connection with the processor for executing software,
wherein the internal engineer device has access to a computer server hosting the system for the procurement of services in connection via the network, in turn, with the client device and the external engineer devices,
wherein the internal engineer device has access to the system for the procurement of services over a call center portal over the interface of the internal engineer device, and
wherein the system for the procurement of services comprising the following software operations:
a module for the triage of service type;
a module for the qualification of external engineers;
a system for the processing of external engineers;
a price set module;
a bidding module; and
an assignment module.

12. The system of claim 11, wherein the module for the triage of service allows a client to select between the following three options: (1) choice between the use of internal engineer services or external engineer services, (2) choice between the use of trouble shooters data, internal engineer or external engineers, or (3) choice between trouble shooters data, internal engineer or client engineer.

13. The system of claim 12, wherein the module for the certification of external engineers includes at least a first set of subsequent certification levels based on a level of knowledge in a first field, at least a second certification level based on a level of knowledge in a second field, wherein one certification level requires knowledge in both the first field and the second field.

14. The system of claim 13, wherein the first field is installation of goods and associated parts and the second field is electrician knowledge.

15. The system of claim 14, wherein the first set of subsequent certification levels includes the swapping of the good, minor installation rights and full installation rights.

16. The system of claim 15, wherein the system includes a recruitment phase, a phase for the initial application by the external engineer, a determination of the certification level by the module for the certification of to external engineer, a background verification phase and an area of work definition phase by the external engineer.

17. The system of claim 16, wherein the price set module is designed for iterative function as entry parameters such as schedule changes, quality of services upgrades are given by the client.

18. The system of claim 17, wherein the bidding module includes a broadcast of a priced job posting to all qualified engineers in a region, reception of bids from external engineers, a broadcast of a report of the top bids within a bidding period, a notification of successful bidder with relevant information, and a notification to customer with external engineer information.

19. The platform of claim 18, wherein the notification to customer includes phone contact with the external engineer.

20. The platform of claim 19, wherein the notification to the successful bidder also includes a start button for the job, to provide the customer with a way to review the work performed.
